(19) United States
(12) Patent Application Publication
(10) Pub. No.: US 2023/0344061 A1
(43) Pub. Date: Oct. 26, 2023

(54) BATTERY MODULE AND BATTERY PACK INCLUDING THE SAME

(71) Applicant: LG Energy Solution, Ltd., Seoul (KR)

(72) Inventors: Tae Geun Kim, Daejeon (KR); Young Il Yoon, Daejeon (KR); Taekyeong Lee, Daejeon (KR)

(21) Appl. No.: 18/026,510

(22) PCT Filed: Oct. 22, 2021
(86) PCT No.: PCT/KR2021/014961

§ 371 Date: Mar. 15, 2023

(30) Foreign Application Priority Data
Nov. 17, 2020 (KR) 10-2020-0153468

(51) Int. Cl. H01M 50/262; H01M 50/211

(52) U.S. Cl. CPC H01M 50/262; H01M 50/211

(57) ABSTRACT

A battery module and battery pack including the same are provided. The battery module includes a battery cell stack in which a plurality of battery cells are stacked; a module frame accommodating the battery cell stack and comprising an open side at one side; and an end plate covering the open side of the module frame, wherein the end plate comprises a mounting portion having a mounting hole formed therein, and wherein the mounting hole is opened at a lower surface of the end plate, and a thread is formed on an inside surface of the mounting hole.

### CROSS CITATION WITH RELATED APPLICATION(S)

This application is a National Stage Application of International Application No. PCT/KR2021/014961, filed on Oct. 22, 2021, which claims the benefit of Korean Patent Application No. 10-2020-0153468 filed on Nov. 17, 2020, the disclosure of which is incorporated herein by reference in its entirety.

### FIELD OF DISCLOSURE

The present disclosure relates to a battery module and a battery pack including the same, and more particularly to a battery module having improved space utilization and a battery pack including the same.

### BACKGROUND

In modern society, as portable devices such as a mobile phone, a notebook computer, a camcorder and a digital camera has been daily used, the development of technologies in the fields related to mobile devices as described above has been activated. In addition, chargeable/dischargeable secondary batteries are used as a power source for an electric vehicle (EV), a hybrid electric vehicle (HEV), a plug-in hybrid electric vehicle (P-HEV) and the like, in an attempt to solve air pollution and the like caused by existing gasoline vehicles using fossil fuel. Therefore, there is a growing need for development of the secondary battery.

Currently commercialized secondary batteries include a nickel cadmium battery, a nickel hydrogen battery, a nickel zinc battery, a lithium secondary battery, and the like. Among them, the lithium secondary battery has come into the spotlight because they have advantages, for example, hardly exhibiting memory effects compared to nickel-based secondary batteries and thus being freely charged and discharged, and having very low self-discharge rate and high energy density.

Such lithium secondary battery mainly uses a lithium-based oxide and a carbonaceous material as a cathode active material and an anode active material, respectively. The lithium secondary battery includes an electrode assembly in which a cathode plate and an anode plate each coated with the cathode active material and the anode active material are disposed with a separator being interposed between them, and a battery case that seals and houses the electrode assembly together with an electrolyte solution.

Generally, the lithium secondary battery may be classified based on the shape of the exterior material into a can type secondary battery in which the electrode assembly is built in a metal can, and a pouch type secondary battery in which the electrode assembly is built in a pouch made of an aluminum laminate sheet.

In the case of a secondary battery used for small-sized devices, two to three battery cells are disposed, but in the case of a secondary battery used for a middle or large-sized device such as an automobile, a battery module in which a large number of battery cells are electrically connected is used. In such a battery module, a large number of battery cells are connected to each other in series or in parallel to form a cell stack, thereby improving capacity and output. In addition, one or more battery modules may be mounted together with various control and protection systems such as BMS (battery management system) and a cooling system to form a battery pack.

FIG. 1 is a perspective view showing a conventional battery module, FIG. 2 is a cross-sectional view taken along the cutting line A-A′ of FIG. 1, and FIG. 3 is a perspective view showing an end plate included in the battery module of FIG. 1. Particularly, FIG. 3 shows the surface of the end plate facing the battery cell.

Referring to FIGS. 1 to 3, a conventional battery module 10 can be manufactured by housing a plurality of battery cells 20 in a module frame 30, and then joining an end plate 40 to the module frame 30. When the battery modules 10 are gathered by a plurality of numbers to form a battery pack, or when the battery modules are mounted on a vehicle or the like, each battery module 10 can be fixed to a structure such as a pack frame (not shown). At this time, the conventional battery module 10 may be fixed by forming a mounting structure at four corners. Specifically, mounting holes 40H into which bolts 40B can be inserted can be formed at both ends of the end plate 40 of the battery module 10. The bolt 40B is inserted in the downward direction into the mounting hole 40H, and the nut 40N is coupled to the end of the bolt 40B, so that the battery module 10 can be fixed to the pack frame or the like.

However, in the case of the conventional battery module 10, since the bolt 40B has a form of being inserted downward, the mounting hole 40H has a form that extends along a height direction (a direction parallel to the z-axis) as shown in the figure. Therefore, referring to FIGS. 2 and 3, waste of the space occurs as much as the space in which the mounting hole 40H is formed between the end plate 40 and the battery cells 20. That is, in order to fix the battery module 10, mounting holes 40H that extend along the height direction were formed at both ends of the end plate 40, but this caused the deterioration of the space utilization of the battery module 10.

Increasing the space utilization of the battery module is directly linked to the performance of the battery pack, such as increasing the energy density of the battery module and the battery pack including the same, or enabling downsizing of the battery pack, there is a need to improve the space utilization of the battery module.

### SUMMARY

It is an object of the present disclosure to provide a battery module capable of providing additional space inside while forming a mounting structure, and a battery pack including the same.

However, the problem to be solved by embodiments of the present disclosure is not limited to the above-described problems, and can be variously expanded within the scope of the technical idea included in the present disclosure.

According to one aspect of the present disclosure, there is provided a battery module comprising: a battery cell stack in which a plurality of battery cells are stacked; a module frame accommodating the battery cell stack and comprising an open side at one side; and an end plate covering the open side of the module frame, wherein the end plate comprises a mounting portion having a mounting hole formed therein, and wherein the mounting hole is opened at a lower surface of the end plate, and a thread is formed on an inside surface of the mounting hole.

A height of the mounting portion may be 0.5 times or less a height of the end plate, and an empty space may be provided in an upper part of the mounting portion between the end plate and the battery cell stack.

The end plate may include a body portion, first and second side portions, an upper side portion and a lower side portion. The body portion may face the battery cell stack, and the first and second side portions, the upper side portion, and the lower side portion may be respectively extended in a direction perpendicular to one surface of the body portion from both sides, an upper side, and a lower side of the body portion.

The mounting hole may be opened at a lower surface of the lower side portion of the end plate, and the mounting portion may be extended along a direction parallel to the one surface of the body portion.

The module frame may further comprise another open side at another side facing the one side, and the end plate is configured by a plurality of numbers and may cover the opened one surface and the opened other surface of the module frame, respectively.

According to another aspect of the present disclosure, there is provided a battery pack comprising: the battery module; a pack frame accommodating the battery module; and a bolt that passes through a through hole formed at a bottom portion of the pack frame and is coupled to the mounting hole.

The bolt may be coupled upwardly to the mounting hole.

The bottom portion of the pack frame may include a mounting plate for supporting the battery module and a lower plate located under the mounting plate. The through hole is formed in the mounting plate, and the bolt may pass through the through hole of the mounting plate and is coupled to the mounting hole.

In the lower plate, an opening may be formed in a portion corresponding to the through hole.

The pack frame may further include a side surface portion located on the side surface of the battery module. The side surface portion may be in contact with each of the mounting plate and the lower plate, and a sealing member may be located between the side surface portion and the mounting plate.

A lower through hole may be formed in the lower plate, and the bolt may pass through the lower through hole of the lower plate and the through hole of the mounting plate and is coupled to the mounting hole.

The pack frame may further include a side surface portion located on the side surface of the battery module, the side surface portion may be in contact with each of the mounting plate and the lower plate, and a sealing member may be located between the side surface portion and the lower plate.

### Advantageous Effects

According to embodiments of the present disclosure, a mounting hole is provided at the lower side of the battery module, and the height of the mounting part is adjusted, thereby capable of forming a mounting structure and at the same time, providing an additional space therein and increasing space utilization.

The effects of the present disclosure are not limited to the effects mentioned above and additional other effects not described above will be clearly understood from the description of the appended claims by those skilled in the art.

### BRIEF DESCRIPTION OF DRAWINGS

FIG. 1 is a perspective view showing a conventional battery module;

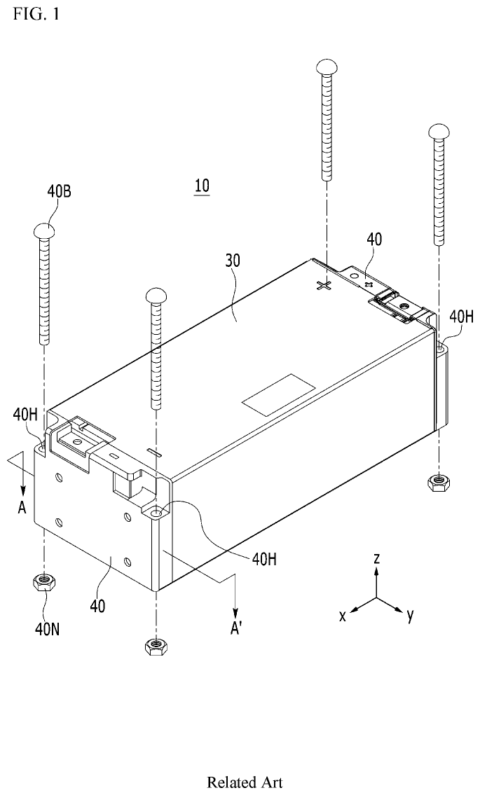

FIG. 2 is a cross-sectional view taken along the cutting line A-A′ of FIG. 1;

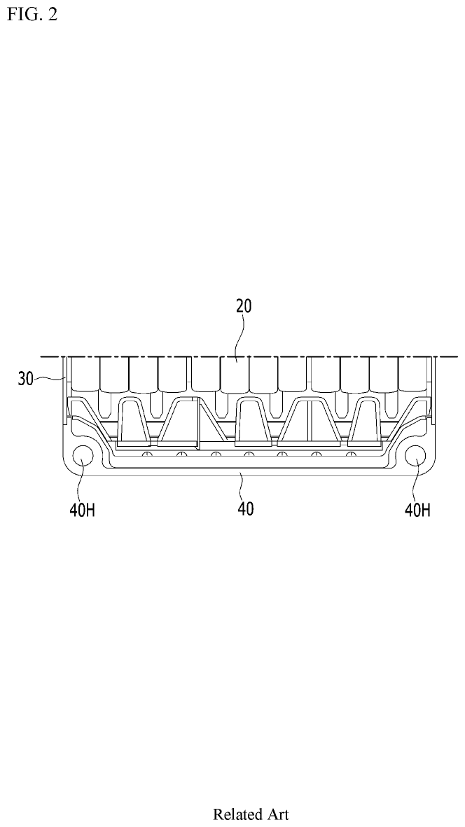

FIG. 3 is a perspective view showing an end plate included in the battery module of FIG. 1;

FIG. 4 is a perspective view showing a battery module according to an embodiment of the present disclosure;

FIG. 5 is an exploded perspective view of the battery module of FIG. 4;

FIG. 6 is a perspective view of a battery cell included in the battery module of FIG. 5;

FIG. 7 is a partial perspective view showing a state in which the lower surface of the battery module of FIG. 4 is inverted so as to face upward.

FIG. 8 is a perspective view of an end plate included in the battery module of FIG. 5;

FIG. 9 is a partial perspective view of a battery module and a pack frame according to an embodiment of the present disclosure;

FIG. 10 is a schematic diagram showing a state in which a battery module according to an embodiment of the present disclosure is mounted on a pack frame; and

FIG. 11 is a schematic diagram showing a state in which a battery module according to a modified embodiment of the present disclosure is mounted on a pack frame.

### DETAILED DESCRIPTION

Hereinafter, various embodiments of the present disclosure will be described in detail with reference to the accompanying drawings so that those skilled in the art can easily carry out them. The present disclosure may be modified in various different ways, and is not limited to the embodiments set forth herein.

A description of parts not related to the description will be omitted herein for clarity, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed on the upper end of the reference portion toward the opposite direction of gravity.

Further, throughout the description, when a portion is referred to as “including” a certain component, it means that the portion can further include other components, without excluding the other components, unless otherwise stated.

Further, throughout the description, when referred to as “planar”, it means when a target portion is viewed from the upper side, and when referred to as “cross-sectional”, it means when a target portion is viewed from the side of a cross section cut vertically.

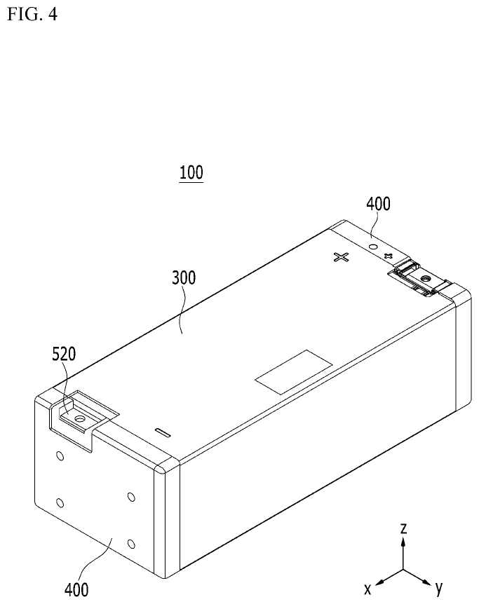

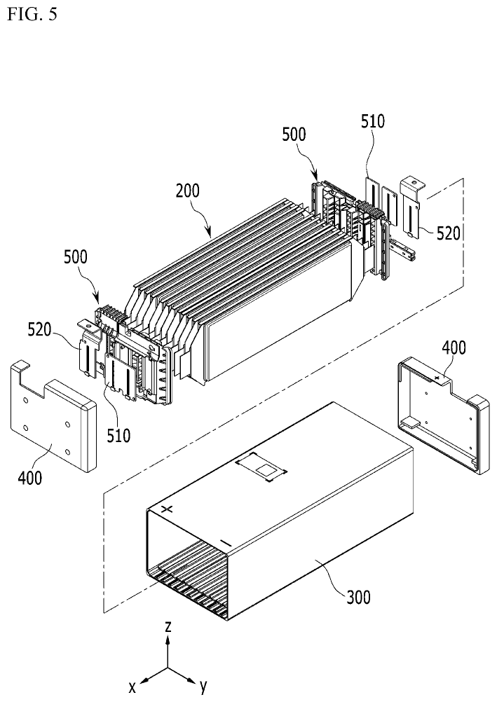

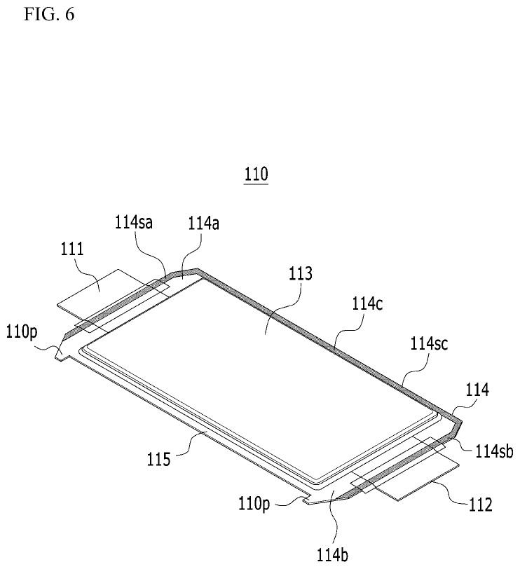

FIG. 4 is a perspective view showing a battery module according to an embodiment of the present disclosure. FIG. 5 is an exploded perspective view of the battery module of FIG. 4. FIG. 6 is a perspective view of a battery cell included in the battery module of FIG. 5.

Referring to FIGS. 4 to 6, a battery module 100a according to one embodiment of the present disclosure includes a battery cell stack 200 in which a plurality of battery cells 110 are stacked, a module frame 300 accommodating the battery cell stack 200 and comprising an open side at one side, and end plate 400 hat covers the opened one surface of the module frame 300.

First, the battery cell 110 is preferably a pouch-type battery cell, and may be formed in a rectangular sheet-like structure. For example, the battery cell 110 according to the present embodiment has a structure in which the two electrode leads 111 and 112 face each other and protrude from one end and the other end, respectively.

Particularly, referring to FIG. 6, the battery cell 110 according to the present embodiment has a structure in which the two electrode leads 111 and 112 face each other and protrude from one end 114a and the other end 114b, respectively. More specifically, the electrode leads 111 and 112 are connected to an electrode assembly (not shown) and are protruded from the electrode assembly (not shown) to the outside of the battery cell 110.

Meanwhile, the battery cell 110 can be manufactured by joining both ends 114a and 114b of a cell case 114 and one side portion 114c connecting them in a state in which an electrode assembly (not shown) is housed in a cell case 114. In other words, the battery cells 110 according to the present embodiment have a total of three sealing portions 114sa, 114sb and 114sc, the sealing portions 114sa, 114sb and 114sc have a structure that is sealed by a method such as heat-sealing, and the remaining other one side portion can be composed of a connection part 115. The cell case 114 can be composed of a laminated sheet including a resin layer and a metal layer.

Further, the connection portion 115 may extend long along one edge of the battery cell 110, and a protrusion portion 110p of the battery cell 110 called a bat-ear may be formed at an end portion of the connection part 115. However, the protrusion portion 110p is an exemplary structure, and the battery cell 110 according to another embodiment of the present disclosure may have a form in which a protrusion portion is not formed and the connection portion 115 extends in a straight line.

The battery cell 110 may be configured by a plurality of numbers, and the plurality of battery cells 110 may be stacked so as to be electrically connected to each other, thereby forming a battery cell stack 200. Particularly, as shown in FIG. 5, the plurality of battery cells 110 can be stacked along the y-axis direction. Thereby, one electrode lead 111 of the battery cells 110 may be protruded toward the x-axis direction, and the other electrode lead 112 may be protruded toward the −x-axis direction.

The module frame 300 may be opened not only at the one surface but also at the other surface facing the one surface. More specifically, the module frame 300 may be opened in both directions in which the electrode leads 111 and 112 protrude with respect to the battery cell stack 200. The end plate 400 may be configured by a plurality of numbers and can cover the opened one surface and the opened other surface of the module frame 300, respectively. The battery cell stack 200 is housed in the module frame 300 and the end plate 400, thereby capable of physically protecting the battery cell stack 200. For this purpose, the module frame 300 and the end plate 400 may include a metal material having a predetermined strength. Meanwhile, the module frame 300 and the end plate 400 may be joined by a method such as welding in a state in which corresponding corner portions are in contact with each other.

Meanwhile, the battery module 100 according to the present embodiment may further include a busbar frame 500 on which a busbar 510 and a terminal busbar 520 are mounted.

The busbar 510 and the terminal busbar 520 can be joined to the electrode leads 111 and 112 of the battery cells 110 in order to electrically connect the plurality of battery cells 110. Specifically, the busbar frame 500 on which the busbar 510 and the terminal busbar 520 are mounted can be disposed on the one surface (x-axis direction) and the other surface (−x-axis direction) of the battery cell stack 200. The one surface (x-axis direction) and the other surface (−x-axis direction) of the battery cell stack 200 correspond to the surfaces in the direction in which the electrode leads 111 and 112 of the battery cells 110 protrude. In other words, the busbar frame 500 may be located between the battery cell stack 200 and the end plate 400.

A lead slit may be formed at the busbar frame 500, and the electrode leads 111 and 112 can be bent after passing through the lead slit, and joined to the busbar 510 or the terminal busbar 520. As long as physical and electrical connection is possible, the joining method is not particularly limited, and weld-joining can be performed as an example.

Meanwhile, a slit may be formed in the busbar 510 or the terminal busbar 520, and the slit may be located so as to correspond to the lead slit of the busbar frame 500. The electrode leads 111 and 112 that have passed through the lead slit may be bent by passing through the slit of the busbar 510 or the slit of the terminal bus bar 520.

Meanwhile, a part of the terminal busbar 520 may be exposed to the outside of the battery module 100. Specifically, an opening is formed in the end plate 400 or an insulating cover (not shown), and a part of the terminal busbar 520 may be exposed as shown in FIG. 4. A part of the exposed terminal busbar 520 can be connected to another battery module or a BDU (battery disconnect unit) or the like to realize a high voltage (HV) connection. Here, the HV connection is a connection that plays a role of a power source for supplying electric power, and refers to a connection between battery cells or a connection between battery modules.

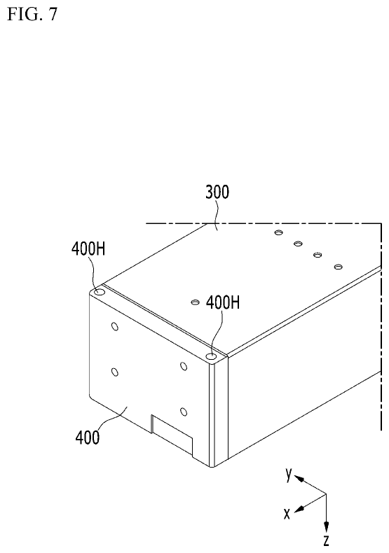

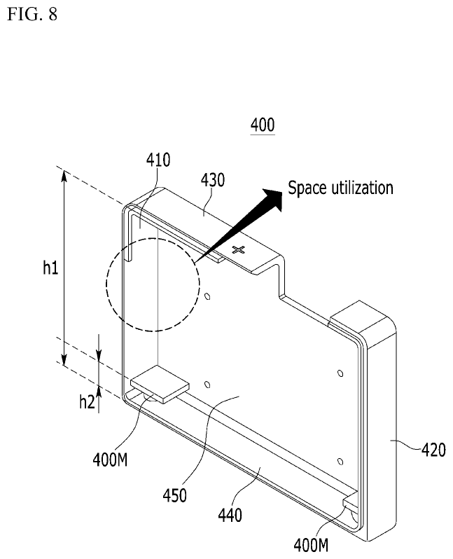

Next, an end plate, a mounting portion, and a mounting hole according to an embodiment of the present disclosure will be described in detail with reference to FIGS. 7 and 8.

FIG. 7 is a partial perspective view showing a state in which the lower surface of the battery module of FIG. 4 is inverted so as to face upward. FIG. 8 is a perspective view of an end plate included in the battery module of FIG. 5. Particularly, FIG. 8 shows a surface of the end plate facing the battery cell stack.

Referring to FIGS. 5, 7 and 8, the end plate 400 according to the present embodiment includes a mounting portion 400M in which a mounting hole 400H is formed. The mounting hole 400H is opened at the lower surface of the end plate 400, and a thread is formed on the inner surface of the mounting hole 400H.

More specifically, the end plate 400 according to the present embodiment may include a body portion 450, first and second side portions 410 and 420, an upper side portion 430, and a lower side portion 440. The body portion 450 is a portion facing the battery cell stack 200, and the first and second side portions 410 and 420, the upper side portion 430, and the lower side portion 440 are portions that are extended in a direction perpendicular to one surface of the body portion 450 from both sides, an upper side, and a lower side of the body portion 450. That is, the end plate 400 according to the present embodiment may have a cover shape that is opened in one surface in the direction in which the battery cell stack 200 is located.

At this time, the mounting hole 400H according to the present embodiment may be opened on the lower surface of the lower portion 440 of the end plate 400, and the mounting portion 400M may extend along a direction parallel to one surface of the body portion 450. Thereby, in the mounting structure for fixing the battery module 100 to the pack frame, etc., the bolt inserted into the mounting hole 400H may be coupled upwardly to the mounting hole 400H.

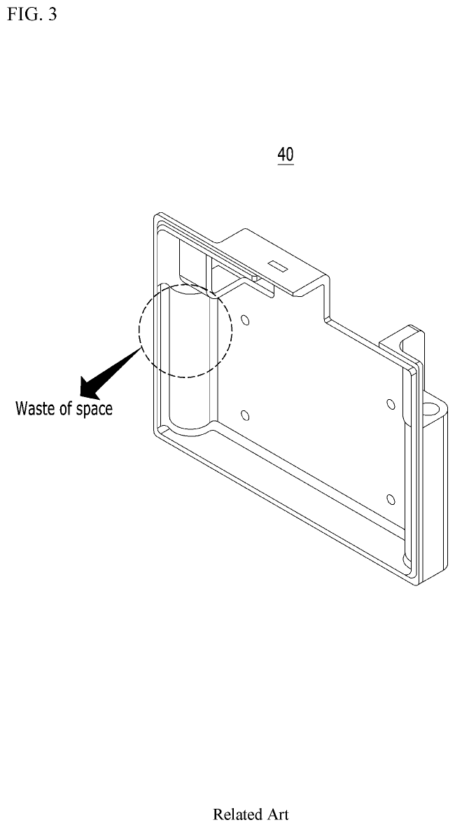

Meanwhile, referring to FIG. 8, the height h2 of the mounting portion 400M in which the mounting hole is formed may be 0.5 times or less the height h1 of the end plate 400. In another example, the height h2 of the mounting portion 400M may be 0.3 times or less, more preferably 0.2 times or less the height h1 of the end plate 400. That is, since the mounting hole 400H according to the present embodiment is opened on the lower surface of the lower portion 440 of the end plate 400, the height of the mounting part 400M does not need to be formed in the same manner as the height of the end plate 400, unlike the conventional end plate 40 shown in FIG. 3. Even if the height h2 of the mounting portion 400M is formed to be low by 0.5 times or less the height h1 of the end plate 400, the battery module 100 can be sufficiently fixed. Therefore, an empty space can be provided in an upper part of the mounting portion 400M between the end plate 400 and the battery cell stack 200. The lower limit of the height is not particularly limited, but the height h2 of the mounting portion 400M may be 0.05 times or more the height h1 of the end plate 400 in order to have the minimum degree of fastening. The conventional battery module 10 has a mounting hole 40H structure that is long in the height direction, and needs to secure a space for mounting and fastening, whereas the battery module 100 according to the present embodiment can implement a mounting hole 400H structure that is short in the height direction, and thus can secure an additional space within the battery module 100. It is possible to utilize the space, such as configuring the conventional wasted space in a direction to increase the battery capacity. Because of this advantage in terms of space utilization, the battery module and the battery pack including the same according to the present embodiment can have advantages in terms of energy density or downsizing.

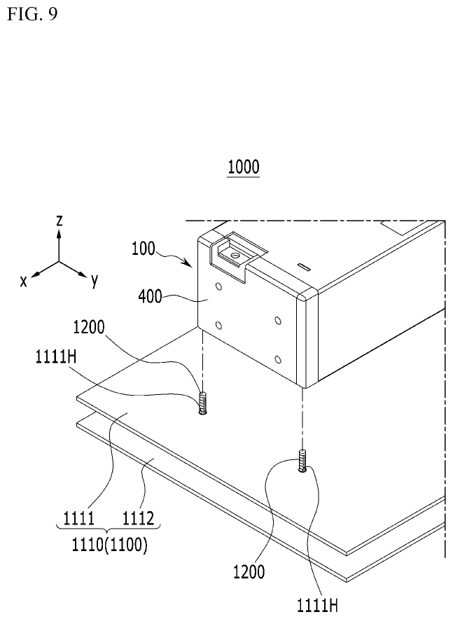

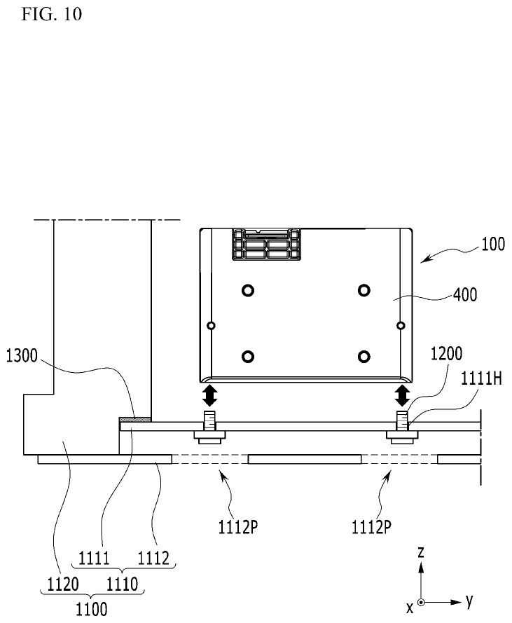

Next, a battery pack according to an embodiment of the present disclosure will be described in detail with reference to FIGS. 9 and 10.

FIG. 9 is a partial perspective view of a battery module and a pack frame according to an embodiment of the present disclosure. FIG. 10 is a schematic diagram showing a state in which a battery module according to an embodiment of the present disclosure is mounted on a pack frame.

Referring to FIGS. 7, 9 and 10, the battery pack 1000 according to an embodiment of the present disclosure includes a battery module 100, a pack frame 1100 accommodating the battery module 100, and a bolt 1200 that passes through the through hole 1111H formed in the bottom portion 1110 of the pack frame 1100 to be coupled to the mounting hole 400H.

The battery modules 100 may be gathered by a plurality of numbers to form a battery pack 1000, wherein each battery module 100 may be fixed to a structure such as the pack frame 1100. At this time, a through hole 1111H is formed in the bottom portion 1110 of the pack frame 1100, and the bolt 1200 passes upwardly through the through hole 1111H, and then can be fastened to the mounting hole 400H of the battery module 100.

More specifically, the bottom portion 1110 of the pack frame 1100 according to the present embodiment may include a mounting plate 1111 for supporting the battery module 100, and a lower plate 1112 located under mounting plate 1111.

By forming the above-mentioned through hole 1111H in the mounting plate 1111, it is possible to support the battery module 100 and at the same time, fix the battery module 100 to the mounting plate 1111, thereby forming a mounting structure. That is, the mounting hole 400H of the battery module 100 and the bolt 1200 may be coupled with the mounting plate 1111 being interposed therebetween.

Meanwhile, the lower plate 1112 is located under the mounting plate 1111, and although not specifically shown in the figure, an equipment such as a cooling water supply pipe for cooling the battery module 100 may be provided between the mounting plate 1111 and the lower plate 1112.

Meanwhile, referring to FIG. 10, in the lower plate 1112 according to the present embodiment, an opening 1112P may be formed in a portion corresponding to the through hole 1111H formed in the mounting plate 1111. That is, an opening 1112P having an opening shape may be formed in each of the portions corresponding to the through hole 1111H with reference to the Z-axis direction. As described above, the bolt 1200 according to the present embodiment is coupled upwardly to the mounting hole 400H of the battery module 100, but a space is needed for mounting the equipment for assembling the bolt 1200. Therefore, by forming the opening 1112P in the lower plate 1112, a space for assembling the bolt 1200 is provided.

Meanwhile, the pack frame 1100 may further include a side surface portion 1120 located not only on the bottom portion 1110 but also on the side surface portion 1120. The side surface portion 1120 can form a stepped structure and come into contact with each of the mounting plate 1111 and the lower plate 1112. At this time, a sealing member 1300 having adhesive properties may be located between the side surface portion 1120 and the mounting plate 1111. That is, the side surface portion 1120 and the mounting plate 1111 are adhered and fixed, and at the same time, a gap therebetween can be sealed by the sealing member 1300. As the sealing member 1300 according to the present embodiment is located between the side surface portion 1120 and the mounting plate 1111, the space between the side surface portion 1120 and the mounting plate 1111 is sealed even if the opening 1112P is formed, whereby it is possible to prevent water or the like from flowing into the pack frame 1100.

Meanwhile, if the side surface portion 1120 and the mounting plate 1111 have adhesive properties so that they can be adhered, fixed, and sealed, the material of the sealing member 1300 is not particularly limited. As described above, a space for assembling the bolt 1200 must be secured, such as an opening 1112P being formed in the lower plate 1112, and it is necessary to seal between the mounting plate 1111 and the side surface portion 1120 to prevent the inflow of water. Thus, it is preferable that the sealing member 1300 is located between the side surface portion 1120 and the mounting plate 1111 to be adhered and sealed.

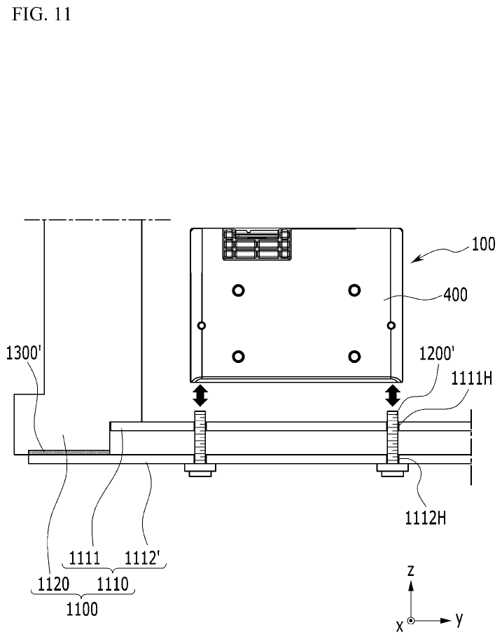

FIG. 11 is a schematic diagram showing a state in which a battery module according to a modified embodiment of the present disclosure is mounted on a pack frame. Parts overlapping with the above-mentioned contents are omitted in order to avoid repetition of the description.

Referring to FIG. 11, the bottom portion 1110 of the pack frame 1100 according to the modified embodiment of the present disclosure may include a mounting plate 1111 for supporting the battery module 100 and a lower plate 1112′ located under mounting plate 1111. The pack frame 1100 may further include a side surface portion 1120 located on the side surface of the battery module 100.

At this time, the lower plate 1112′ according to the present embodiment can be formed with a lower through hole 1112H rather than an opening, and the lower through hole 1112H of the lower plate 1112′ may be located so as to correspond to the through hole 1111H of the mounting plate 1111 with reference to the Z-axis direction. Further, the bolt 1200′ according to the present embodiment is formed longer than the bolt 1200 described in FIG. 10, and after sequentially passing through the lower through hole 1112H of the lower plate 1112′ and the through hole 1111H of the mounting plate 1111, it can be coupled to the mounting hole 400H of the battery module 100.

At this time, the adhesive sealing member 1300′ according to the present embodiment may be located between the side surface portion 1120 and the lower plate 1112′. Since the lower through hole 1112H of the lower plate 1112′ is naturally sealed by the insertion of the bolt 1200′ according to the present embodiment, a sealing member 1300′ for preventing water from entering the pack frame 1100 can be located between the side surface portion 1120 and the lower plate 1112′. That is, the sealing member 1300′ according to the present embodiment can play a function of preventing water inflow while being located between the side surface portion 1120 and the lower plate 1112′. Meanwhile, if necessary, a ring-shaped stopper for sealing may be disposed between the head of the bolt 1200′ and the lower plate 1112′ according to the present embodiment.

The terms representing directions such as the front side, the rear side, the left side, the right side, the upper side, and the lower side have been used in embodiments of the present disclosure, but the terms used are provided simply for convenience of description and may become different according to the position of an object, the position of an observer, or the like.

The one or more battery modules according to embodiments of the present disclosure described above can be mounted together with various control and protection systems such as a battery management system (BMS) and a cooling system to form a battery pack.

The battery module or the battery pack can be applied to various devices. For example, it can be applied to vehicle means such as an electric bike, an electric vehicle, and a hybrid electric vehicle, and may be applied to various devices capable of using a secondary battery, without being limited thereto.

Although the invention has been shown and described above with reference to the preferred embodiments, the scope of the present disclosure is not limited thereto, and numerous other modifications and improvements can be devised by those skilled in the art using the basic principles of the invention described in the appended claims, which also falls under the spirit and scope of the present disclosure.

### DESCRIPTION OF REFERENCE NUMERALS

100: battery module
200: battery cell stack
300: module frame
400: end plate
400M: mounting portion
400H: mounting hole

1. A battery module comprising:
a battery cell stack in which a plurality of battery cells are stacked;
a module frame accommodating the battery cell stack and comprising an open side at one side; and
an end plate covering the open side of the module frame,
wherein the end plate comprises a mounting portion having a mounting hole formed therein, and
wherein the mounting hole is opened at a lower surface of the end plate, and a thread is formed on an inside surface of the mounting hole.

2. The battery module according to claim 1, wherein
a height of the mounting portion is 0.5 times or less a height of the end plate, and
wherein an empty space is provided in an upper part of the mounting portion between the end plate and the battery cell stack.

3. The battery module according to claim 1, wherein
the end plate comprises a body portion, first and second side portions, an upper side portion, and a lower side portion,
wherein the body portion faces the battery cell stack, and
wherein the first and second side portions, the upper side portion, and the lower side portion are respectively extended in a direction perpendicular to one surface of the body portion from both sides, an upper side, and a lower side of the body portion.

4. The battery module according to claim 3, wherein
the mounting hole is opened at a lower surface of the lower side portion of the end plate, and
the mounting portion is extended along a direction parallel to the one surface of the body portion.

5. The battery module according to claim 1, wherein
the module frame further comprises another open side at another side facing the one side, and
wherein a plurality of end plates cover the open side at the one side and the another open side at the another side of the module frame, respectively.

6. A battery pack comprising:
the battery module according to claim 1;
a pack frame accommodating the battery module; and
a bolt that passes through a through hole formed at a bottom portion of the pack frame, and is coupled to the mounting hole.

7. The battery pack according to claim 6, wherein
the bolt is coupled upwardly to the mounting hole.

8. The battery pack according to claim 6, wherein
the bottom portion of the pack frame comprises a mounting plate supporting the battery module, and a lower plate located under the mounting plate, and
wherein the through hole is formed in the mounting plate, and the bolt passes through the through hole of the mounting plate and is coupled to the mounting hole.

9. The battery pack according to claim 8, wherein
in the lower plate, an opening is formed in a portion corresponding to the through hole.

10. The battery pack according to claim 8, wherein
the pack frame further comprises a side surface portion located on a side surface of the battery module,
wherein the side surface portion is in contact with each of the mounting plate and the lower plate, and
wherein a sealing member is located between the side surface portion and the mounting plate.

11. The battery pack according to claim 8, wherein
a lower through hole is formed in the lower plate, and
wherein the bolt passes through the lower through hole of the lower plate and the through hole of the mounting plate and is coupled to the mounting hole.

12. The battery pack according to claim 8, wherein
the pack frame further comprises a side surface portion located on a side surface of the battery module,
wherein the side surface portion is in contact with each of the mounting plate and the lower plate, and
wherein a sealing member is located between the side surface portion and the lower plate.
